(19) United States
(12) Patent Application Publication
(10) Pub. No.: US 2022/0242658 A1
(43) Pub. Date: Aug. 4, 2022

(54) TEA BAGS AND THE INFUSION PADS AND METHOD OF MAKING THEM

(71) Applicant: PA Knowledge Limited, London (GB)

(72) Inventors: Viju Vasishta, Melbourn (GB); Alexander Yon, Melbourn (GB)

(21) Appl. No.: 17/596,181

(22) PCT Filed: Jun. 4, 2020
(86) PCT No.: PCT/GB2020/051355

§ 371 Date: Dec. 3, 2021

(30) Foreign Application Priority Data
Jun. 6, 2019 (GB) 1908081.1

(51) Int. Cl. B65D 85/808; B65D 65/46; B65B 29/02; B31B 70/62

(52) U.S. Cl. CPC B65D 85/8085; B65D 65/466; B31B 2241/00; B31B 70/62; B65B 29/028

(57) ABSTRACT

A first aspect of the invention provides an infusion product for making a beverage by soaking the infusion product in a liquid, the infusion product comprising: a pouch formed from one or more permeable sheets of a first plant material, at least two portions of the pouch being joined together at a seam portion by an adhesive; a second plant material within the pouch, the second plant material being configured such that an extract from the second plant material infuses into the first liquid when the infusion product is soaked in the liquid to make the beverage; wherein the adhesive comprises corn zein.

### CROSS-REFERENCE TO RELATED APPLICATIONS

This application is a 371 National Phase Entry of International Patent Application No. PCT/GB2020/051355 filed on Jun. 4, 2020, which claims the benefit of British Patent Application No. 1908081.1 filed on Jun. 6, 2019, the contents of which are incorporated herein by reference in their entirety.

### FIELD OF THE INVENTION

The present invention relates to infusion products for making a beverage and methods of making infusion products.

### BACKGROUND OF THE INVENTION

A teabag is an example of an infusion product that can be soaked in water to make a beverage, i.e., tea. With approximately 165 million cups a day drank by the British alone, and 96% of this prepared using a tea bag, it is often a single use product which until recently was believed to be sustainable. However, a recent survey found that plastic fiber fragments still remained after teabags were composted. These were the remains of polypropylene (PP) fibers, which are woven into the cellulose filter paper sheets in order to provide a heat sealing capability. On average teabags are 70%-80% paper fibers, and the rest is PP. This creates environmental problems.

It is an aim of the present disclosure to at least partially address the problems above.

### SUMMARY OF THE INVENTION

A first aspect of the invention provides an infusion product for making a beverage by soaking the infusion product in a liquid, the infusion product comprising: a pouch formed from one or more permeable sheets of a first plant material, at least two portions of the pouch being joined together at a seam portion by an adhesive; a second plant material within the pouch, the second plant material being configured such that an extract from the second plant material infuses into the first liquid when the infusion product is soaked in the liquid to make the beverage; wherein the adhesive comprises corn zein.

Optionally, the adhesive comprises at least 80 wt. % corn zein.

Optionally, the two portions of the pouch are joined together substantially by the corn zein.

Optionally, the seam portion does not substantially comprise a thermoplastic.

Optionally, the first plant material comprises at least one of: lokta fibers, cotton fibers, hemp fibers and abaca fibers.

Optionally, the second plant material comprises material from at least one of: fruits, herbs, medicinal plants, tea, vegetables and spices.

Optionally, the second plant material is in a state in which the extract from the second plant material is substantially retained within the second plant material.

Optionally, the infusion product does not comprise any plastic.

Optionally, the infusion product is made entirely from biodegradable materials.

A second aspect of the invention provides a method of making an infusion product for making a beverage by soaking the infusion product in a first liquid, the method comprising: forming a pouch from one or more permeable sheets of a first plant material, the pouch being at least partially filled with a second plant material, the second plant material being configured such that an extract from the second plant material infuses into the first liquid when the infusion product is soaked in the liquid to make the beverage; joining at least two portions of the pouch together at a seam portion by an adhesive comprising corn zein.

Optionally, the adhesive is applied to at least one of the respective surfaces of the at least two portions of the pouch configured to face each other at the seam portion.

Optionally, the adhesive is applied by means of a solution comprising the adhesive. Optionally, the solution comprises 5-15% w/v of corn zein. Optionally, the solution comprises 10% w/v of corn zein. Optionally, the solvent substantially comprises ethanol. Optionally, the solvent additionally comprises water. Optionally, the adhesive solution is dried. Optionally, the dried adhesive comprises at least 80 wt. % corn zein.

Optionally, the step of joining the at least two portions of the pouch together comprises applying heat to the seam portion. Optionally, the step of joining the at least two portions of the pouch together comprises applying pressure to the seam portion at the same time as applying heat to the seam portion.

Optionally, the two portions of the pouch are joined together substantially by the corn zein.

Optionally, the seam portion does not substantially comprise a thermoplastic.

Optionally, the first plant material comprises at least one of: lokta fibers, cotton fibers, hemp fibers and abaca fibers.

Optionally, the second plant material comprises material from at least one of: fruits, herbs, medicinal plants, tea, vegetables and spices.

Optionally, the second plant material is in a state in which the extract from the second plant material is substantially retained within the second plant material.

Optionally, the infusion product does not comprise any plastic.

Optionally, the infusion product is made entirely from biodegradable materials.

### BRIEF DESCRIPTION OF THE FIGURES

The invention is described below by way of examples and with reference to the accompanying drawings, in which:

FIG. 1 schematically shows a first view of an example infusion product; and

FIG. 2 schematically shows a cross section through the example infusion product.

### DETAILED DESCRIPTION OF THE INVENTION

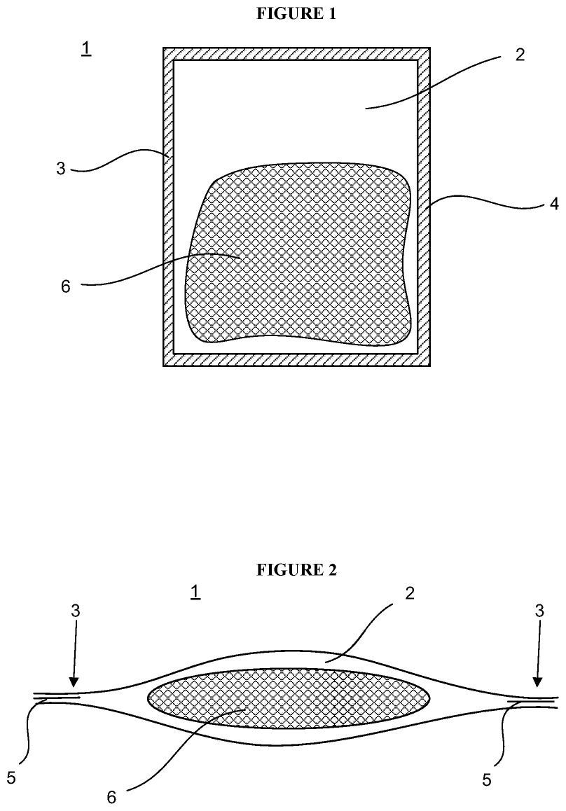

FIGS. 1 and 2 show an example of an infusion product (1) in accordance with the present invention. An infusion product may generally refer to products, such as tea bags, which are soaked in a liquid, such as water, so that flavorings within the product infuse into the liquid to make a beverage. Accordingly, the infusion product (1) of the invention is for making a beverage by soaking the infusion product in a liquid, e.g., water. In one specific example, the infusion product (1) described herein provides a tea bag, for making tea.

The infusion product (1), as shown in FIGS. 1 and 2, generally comprises a pouch (2) formed from one or more permeable sheets (4) of a first plant material, at least two portions of the pouch being joined together at a seam portion (3) by an adhesive (5). A second plant material (6) (e.g., particles thereof) may be provided within the pouch (2). The second plant material (6) is configured such that an extract from the second plant material infuses into a liquid when the infusion product is soaked in the liquid to make the beverage.

In the illustrated example, the pouch (2) is formed from two sheets (3) by joining the two sheets (3) at the perimeter of the infusion product (1). One advantage of using the two-sheet arrangement of the illustrated example, is that multiple infusion products can be formed relatively easily from two sheets. For example, the second plant material may be located in cells of a grid-like pattern between the first and second sheets, adhesive being located along a grid defining the cells. After joining the sheets, each cell can be cut out to form an individual infusion product.

However, a single sheet could be used instead, which is folded and joined to itself, for example. Of course, sheets may be folded and joined in any number of different ways to create more complex shaped pouches, such as the pyramid shape used by many conventional tea bags. However, the specific shape and arrangement of the pouch is not the primary concern of the invention.

The primary concern of the invention is how portions of the pouch (2) are joined together. In particular, the invention uses an adhesive (5) comprising corn zein (a protein derived from maize) to join portions of the pouch (2) together.

The infusion product (1) of the invention can be made by forming a pouch (2) from one or more permeable sheets (4) of a first plant material, the pouch (2) being at least partially filled a second plant material (6). Forming the pouch (2) filled with the second plant material (6) can be done in a number of ways. For example, the pouch (2) could be formed first, then filled with the second plant material (6). Alternatively, the pouch (2) could be formed around the second plant material (6). In some case, the pouch (2) may be formed and filled simultaneously.

At some stage in the process, at least two portions of the pouch (2) will be joined together at a seam portion (3) by the adhesive (5) comprising corn zein. The joining may be required to form the pouch (2) into the desired shape and/or to seal the pouch (2).

In one method of making the infusion product (1), the adhesive (5) may be applied to at least one of the respective surfaces of the at least two portions of the pouch (2) configured to face each other at the seam portion (3). Preferably, the adhesive (5) may be applied to both mutually facing surfaces.

The adhesive (5) may be applied (5) by means of a solution comprising the adhesive (5). The solution may comprise 5-15% w/v of corn zein, preferably 10% w/v of corn zein. The solvent may comprise ethanol as the main constituent i.e., greater than 50% by weight. The solvent additionally comprises water. In one example method a solvent having a ratio of 3:1 ethanol to water was used. However, other ratios could be used instead, e.g., between 2:1 and 4:1 ethanol:water.

The adhesive solution may be applied in any number of ways. For example, the sheets (4) forming the pouch (2) may be dipped in adhesive. Alternatively, the adhesive solution may be brushed, sponged, sprayed or jetted onto the sheets (4) forming the pouch (2).

After applying the adhesive solution, the adhesive solution may be dried. This could be allowed to happen or assisted using a heater, oven, dehydrator or the like. The adhesive solution may be dried for a period of time sufficient to evaporate most of the solvent, e.g., 90% of the solvent by weight. With a 10% w/v of corn zein in a 3:1 ethanol:water solution, this could be from 1 to 10 minutes, usually around 1 minute in normal room conditions.

After applying the adhesive solution, the sheets (4) forming the pouch (2) may be arranged to form a seam portion (3) to be joined. This may occur before or after the optional drying step. Heat may be applied to the seam portion (3) to join the two portions of the pouch (2) at the seam portion (3). Additionally, pressure may be applied to the seam portion (3), e.g., while the seam portion (3) is hot.

In one example method heat and pressure are applied to the seam portion (3) simultaneously, e.g., by a single device. A commercially available heat sealer, such as a Davpack™ Impulse Heat Sealer With Cutter, may be used, for example. However, other heat sealing means may also be used.

The heating step, and optional drying step, substantially removes the solvent from the seam portion (3). Accordingly, the dried (after heating and optional drying step) adhesive solution may comprise at least 80 wt. % corn zein, preferably at least 90%.

The portions of the pouch (2) are joined substantially by the corn zein. Therefore there is no need to include a plastic (e.g., thermoplastic) in the sheets (4) forming the pouch (2) or in the adhesive (5). Accordingly, seam portion (3) may not comprise a thermoplastic or other plastic. Preferably, the infusion product (1) does not comprise any plastic. Preferably still the infusion product (1) is made entirely from biodegradable materials. The infusion product (1), being made entirely from plant materials, may be disposed of along with food waste or composted after use.

The first plant material (2) may comprise cellulosic fibers, such as wood fibers. The fibers may comprise at least one of: lokta fibers, cotton fibers, hemp fibers and abaca fibers. Preferably, lokta fibers are used. However, the fibers of first plant material (2) may be any paper making plant fibers, for example, e.g., fibers from recycled paper.

The second plant material (6) may comprise material from fruits, herbs, medicinal plants, tea, vegetables and/or spices. These may be for example selected from artemisia, balm, basil, chamomile, chive, cloves, coffee, coriander, dill, garlic, ginger, ginseng, gingko, jasmine, lavender, mint, orange blossom, oregano, persil, rooibos, Rosa centifolia, rosemary, thyme, turmeric, sage, pepper, chili pepper, Stevia rebaudiana, tarragon, white tea, yellow tea, green tea, oolong tea, black tea, pu-erh tea, vanilla, red or green vine, violet, and/or willow. However, it should be understood that this list is not exhaustive. Any plant material suitable for making a beverage may be used. Preferably, the second plant material (6) comprises tea, e.g., black tea.

The infusion products described above and/or made by the methods described above maintain the taste of tea and the user experience, compared to teabags. The resulting cup of tea is similar to that which is already on the market. There is little to no sedimentation left behind and the infusion product maintains its structure when placed in water at approximately 80° C.

The product is entirely made from plant materials so is completely home compostable. The product is simple to manufacture, made from completely food grade materials and cost effective. Furthermore, the product is able to be stored over an extended period of time.

What is claimed is:

1. An infusion product for making a beverage by soaking the infusion product in a liquid, the infusion product comprising:
a pouch formed from one or more permeable sheets of a first plant material, at least two portions of the pouch being joined together at a seam portion by an adhesive;
a second plant material within the pouch, the second plant material being configured such that an extract from the second plant material infuses into the liquid when the infusion product is soaked in the liquid to make the beverage;
wherein the adhesive comprises corn zein.

2. The infusion product of claim 1, wherein the adhesive comprises at least 80 wt % corn zein.

3. The infusion product of claim 1 or 2, wherein the two portions of the pouch are joined together substantially by the corn zein.

4. The infusion product of any preceding claim, wherein the seam portion does not substantially comprise a thermoplastic.

5. The infusion product of any preceding claim, wherein the first plant material comprises at least one of: lokta fibres, cotton fibres, hemp fibres and abaca fibres.

6. The infusion product of any preceding claim, wherein the second plant material comprises material from at least one of: fruits, herbs, medicinal plants, tea, vegetables and spices.

7. The infusion product of any preceding claim, wherein the second plant material is in a state in which the extract from the second plant material is substantially retained within the second plant material.

8. The infusion product of any preceding claim, wherein the infusion product does not comprise any plastic.

9. The infusion product of any preceding claim, wherein the infusion product is made entirely from biodegradable materials.

10. A method of making an infusion product for making a beverage by soaking the infusion product in a liquid, the method comprising:
forming a pouch from one or more permeable sheets of a first plant material, the pouch being at least partially filled with a second plant material, the second plant material being configured such that an extract from the second plant material infuses into the liquid when the infusion product is soaked in the liquid to make the beverage;
joining at least two portions of the pouch together at a seam portion by an adhesive comprising corn zein.

11. The method of claim 10, wherein the adhesive is applied to at least one of the respective surfaces of the at least two portions of the pouch configured to face each other at the seam portion.

12. The method of any one of claim 10 or 11 wherein the adhesive is applied by means of a solution comprising the adhesive.

13. The method of claim 12, wherein the solution comprises 5-15% w/v of corn zein

14. The method of claim 12, wherein the solution comprises 10% w/v of corn zein.

15. The method of any one of claims 12 to 14, wherein the solvent comprises ethanol as a main constituent.

16. The method of claim 15, wherein the solvent additionally comprises water.

17. The method of any one of claims 12 to 16, wherein the adhesive solution is dried.

18. The method of claim 17, wherein the dried adhesive comprises at least 80 wt % corn zein.

19. The method of any one of claims 10 to 18, wherein the step of joining the at least two portions of the pouch together comprises applying heat to the seam portion.

20. The method of claim 19, wherein the step of joining the at least two portions of the pouch together comprises applying pressure to the heated seam portion.

21. The method of any one of claims 10 to 20, wherein the two portions of the pouch are joined together substantially by the corn zein.

22. The method of any one of claims 10 to 21, wherein the seam portion does not substantially comprise a thermoplastic.

23. The method of any one of claims 10 to 22, wherein the first plant material comprises at least one of: lokta fibres, cotton fibres, hemp fibres and abaca fibres.

24. The method of any one of claims 10 to 23, wherein the second plant material comprises material from at least one of: fruits, herbs, medicinal plants, tea, vegetables and spices.

25. The method of any one of claims 10 to 24, wherein the second plant material is in a state in which the extract from the second plant material is substantially retained within the second plant material.

26. The method of any one of claims 10 to 25, wherein the infusion product does not comprise any plastic.

27. The infusion product of any preceding claim, wherein the infusion product is made entirely from biodegradable materials.
